(19) United States
(12) Patent Application Publication
(10) Pub. No.: US 2015/0326596 A1
(43) Pub. Date: Nov. 12, 2015

(54) CLOUD BASED METHOD AND APPARATUS FOR MONITORING INTERNET USAGE

(71) Applicant: Tencent Technology (Shenzhen) Company Limited, Shenzhen (CN)

(72) Inventors: Hui Zhang, Shenzhen (CN); Jian Liu, Shenzhen (CN)

(73) Assignee: TENCENT TECHNOLOGY (SHENZHEN) COMPANY LIMITED, Shenzhen (CN)

(21) Appl. No.: 14/796,880

(22) Filed: Jul. 10, 2015

Related U.S. Application Data
(63) Continuation of application No. PCT/CN2013/088639, filed on Dec. 5, 2013.

(30) Foreign Application Priority Data
Feb. 5, 2013 (CN) 201310046139.5

(51) Int. Cl. H04L 29/06

(52) U.S. Cl. CPC H04L 63/1425; H04L 63/20

(57) ABSTRACT

A cloud based method and apparatus for monitoring internet usage are provided. The method comprises: receiving a website inquiry instruction sent by a client, wherein the instruction comprises a website identifier; determining whether the website is a website to be monitored; and if the website is a website to be monitored, processing the website inquiry instruction in accordance with a security policy pre-stored in a server, wherein the security policy is set by the client. Since the security policy is stored on a server, it cannot be easily circumvented by the user, and its effectiveness is enhanced.

### CROSS-REFERENCE TO RELATED APPLICATIONS

This application is a continuation of International Patent Application No. PCT/CN2013/088639, entitled “Cloud Based Method and Apparatus for Monitoring internet usage,” filed on Dec. 5, 2013. This application claims the benefit and priority of Chinese Patent Application No. 201310046139.5, entitled “Cloud Based Method and Apparatus for Monitoring internet usage,” filed on Feb. 5, 2013. The entire disclosures of each of the above applications are incorporated herein by reference.

### TECHNICAL FIELD

The present invention relates to the internet, and more particularly to a cloud based method and apparatus for monitoring internet usage.

### BACKGROUND

Users are constantly demanding better performance on each aspect of the internet.

Let's consider the use of the internet by juveniles, for example. Currently, juveniles' internet use has become a hot-button issue for families, schools, or even the society at large. Due to their lack of self-control, juveniles often use the internet excessively, even to the point of addiction, particular for pornographic websites and online games. Pornographic websites are particularly harmful to juveniles.

To prevent the access of undesirable websites by the juveniles, security software is often installed on client terminals to monitor or filter the contents of the visited websites. When the client visits a website, the security software intercepts the URL of the website, determines the status of the website (such as whether the website is safe or malicious), and limit or record the accesses to the website in accordance with the security policy set in the client.

In the above mentioned methods of monitoring the undesirable websites, since the security policy is set in the client, a juvenile might be able to circumvent the security policy through some means, which can make the monitoring ineffectively.

Therefore, there is a need to address the above mentioned issues in the prior art.

### SUMMARY OF THE INVENTION

The embodiments of the present invention provide a cloud based method for monitoring internet usage to address the issues in the prior art so as to effectively monitor the use of the internet.

In accordance with embodiments of the present invention, a cloud based method for monitoring internet usage is provided, the method comprising: receiving a website inquiry instruction sent by a client, wherein the instruction comprises a website identifier; determining whether the website is a website to be monitored; and if the website is a website to be monitored, processing the website inquiry instruction in accordance with a security policy pre-stored in a server, wherein the security policy is set by the client.

In accordance with embodiments of the present invention, a cloud based apparatus for monitoring internet usage is provided, the apparatus comprising: an instruction receiving module for receiving a website inquiry instruction sent by a client, wherein the instruction comprises a website identifier; a determination module for determining whether the website is a website to be monitored; and a website processing module for, if the website is a website to be monitored, processing the website in accordance with a security policy pre-stored in a server, wherein the security policy is set by the client.

In accordance with embodiments of the present invention, security policy is set and stored in a server, and enforced by security software on the client through a GUID. When a website inquiry instruction is received from a client, the server determines whether the website is a website to be monitored, and if so, process the website in accordance with the preset security policy. Obviously, Since the security policy is stored on a server, it cannot be easily circumvented by the user, and its effectiveness is enhanced.

### BRIEF DESCRIPTION OF THE DRAWINGS

To better illustrate the technical features of the embodiments of the present invention, various preferred embodiments of the present invention will be briefly described in conjunction with the accompanying drawings.

FIG. 1 is an exemplary flowchart for setting security policy in a cloud based method for monitoring internet usage in accordance with an embodiment of the present invention.

FIG. 2 is an exemplary flowchart for a cloud based method for monitoring internet usage in accordance with an embodiment of the present invention.

FIG. 3 is an exemplary structural diagram for a cloud based apparatus for monitoring internet usage in accordance with an embodiment of the present invention.

FIG. 4 is an exemplary structural diagram for a website processing module in a cloud based apparatus for monitoring internet usage in accordance with an embodiment of the present invention.

### DESCRIPTION OF THE PREFERRED EMBODIMENTS

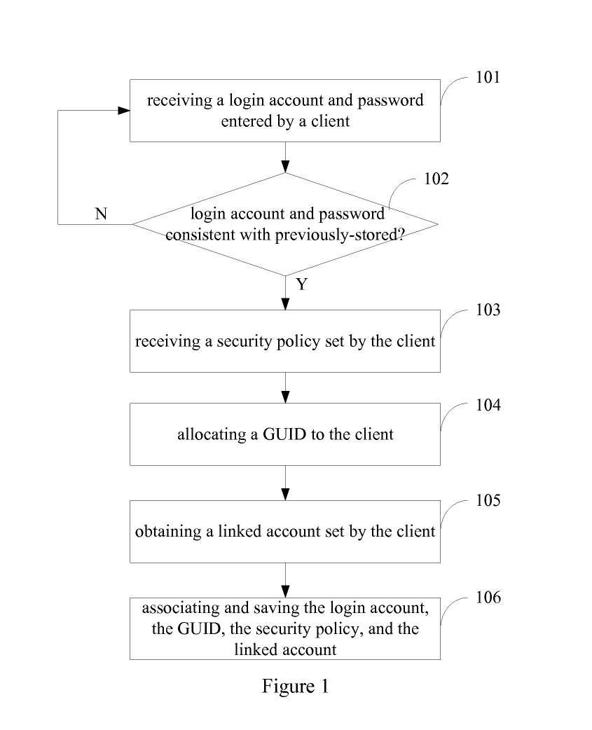

FIG. 1 is an exemplary flowchart for setting security policy in a cloud based method for monitoring internet usage in accordance with an embodiment of the present invention. As shown in FIG. 1, setting security policy includes the following steps.

Step 101: receiving a login account and password entered by a client.

Step 102: determining whether the login account and password are consistent with what were stored previously; if so, proceeding to step 103; otherwise, proceeding to step 101.

Step 103: receiving a security policy set by the client.

According to one embodiment of the present invention, a security policy can be set in a client by the user, and a cloud server can obtain the security policy from the client.

According to one embodiment of the present invention, the security policy is composed of three parts: {a GUID, the category of the website to be monitored, processing action}. Specifically, if it is monitored that the client with a GUID is visiting a website to be monitored, the corresponding processing action will be taken. For example, the category of the website to be monitored can include undesirable websites such as pornographic, violent websites or game websites; and the processing action can include denying access to the website, recording accesses to the website in a log, and sending a prompt message to the client.

According to one embodiment of the present invention, the server can categorize the websites to be monitored (e.g., malicious website or pornographic website etc.) in advance, and generate a list of categories, i.e., a blacklist, and save the categories in a list. When the website visited by the client is in the category list, the corresponding processing action can be taken in accordance with the security policy.

Alternative, the security policy can be set by the server, and downloaded to the client.

Step 104: allocating a GUID to the client.

In step 104, the GUID is a 128-bit number, and is configured to identify the client or certain application on the client, wherein the application can be a security software, a browser plug-in, or other application on the client that can communicate with the cloud server.

Step 105: obtaining a linked account set by the client.

In step 105, when the client set the security policy, a linked account can be set, such as a mobile phone number, an e-mail account, or an instant messaging account such as QQ account.

Step 106: associating and saving the login account, the GUID, the security policy, and the linked account.

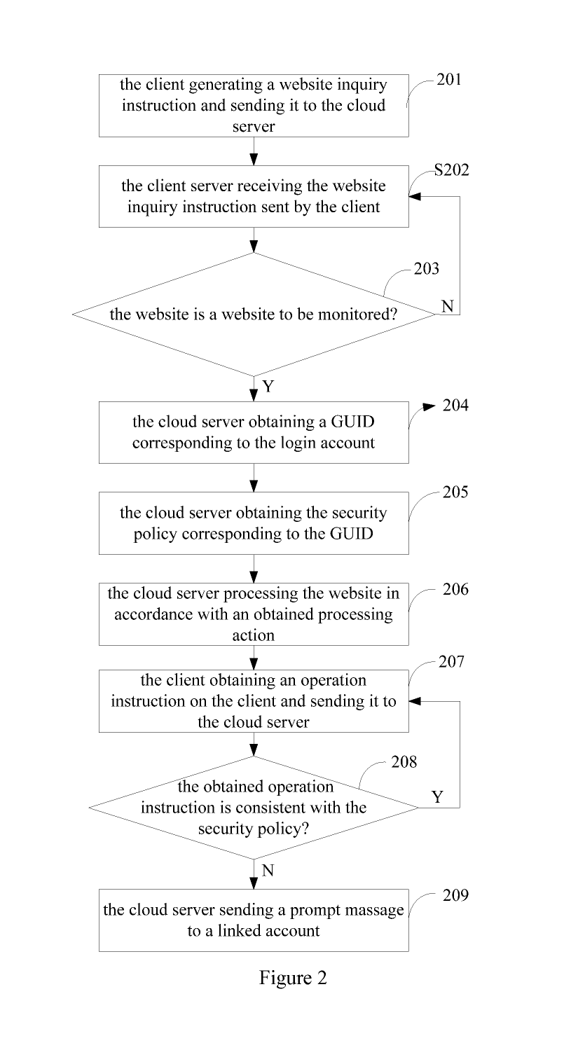

FIG. 2 is an exemplary flowchart for a cloud based method for monitoring internet usage in accordance with an embodiment of the present invention. As shown in FIG. 2, the method includes the following steps.

Step 201: the client generating a website inquiry instruction and sending the website inquiry instruction to the cloud server when accessing a website. In step 201, the website inquiry instruction includes a website identifier and the current login account.

For instance, when the client enters a website identifier (URL), the pre-stored security software in the client obtains the URL and generate a website inquiry instruction based on the URL and the current login account, and sends the instruction to the cloud server.

Step 202: the client server receiving the website inquiry instruction sent by the client.

Step 203: the cloud determining whether the website is a website to be monitored, such as a malicious or pornographic website; if so, proceeding to step 204; otherwise proceeding to step 201.

Step 204: the cloud server obtaining a GUID corresponding to the login account.

In step 204, the login account has a one-to-one correspondence relationship with the GUID and the security policy.

Step 205: the cloud server obtaining the security policy corresponding to the GUID.

Step 206: the cloud server processing the website in accordance with an obtained processing action.

According to one embodiment of the present invention, the security policy is composed of three parts: {a GUID, the category of the website to be monitored, processing action}. Specifically, if it is monitored that the client with a GUID is visiting a website to be monitored, the corresponding processing action will be taken. For example, a security policy of {321, pornographic website, denying access to the website} means that, when a client with a GUID 321 visits a pornographic website, the processing action is denying access to the website.

Step 207: the client obtaining an operation instruction on the client, such as one regarding the website, and sending the operation instruction to the cloud server.

For instance, after denying access to the pornographic website, the cloud server can further obtain other operation instructions of the user on the client to determine whether the client is violating the pre-set security policy.

Step 208: the cloud server determining whether the obtained operation instruction is consistent with the processing action of the security policy, and if so, proceeding to step 207; if not, proceeding to step 209.

Step 209: the cloud server sending a prompt massage to a linked account. For instance, the cloud sends a message regarding visiting a pornographic website to the linked account to allow such as a guardian to timely monitor the internet usage of the client.

According to this embodiment of the present invention, a security policy can be preset in a client, and stored in a cloud server. The security policy can be used to control accesses to websites to be monitored, or record and monitor accesses to certain types of websites for the purpose of monitoring juveniles internet usage.

According to this embodiment of the present invention, internet usage can be effectively monitored by associating a GUID with a login account, a client, or an application on the client, such as security software, a browser plug-in, or an online game. Since the security policy is stored on a server, it cannot be easily circumvented by the user, and its effectiveness is enhanced.

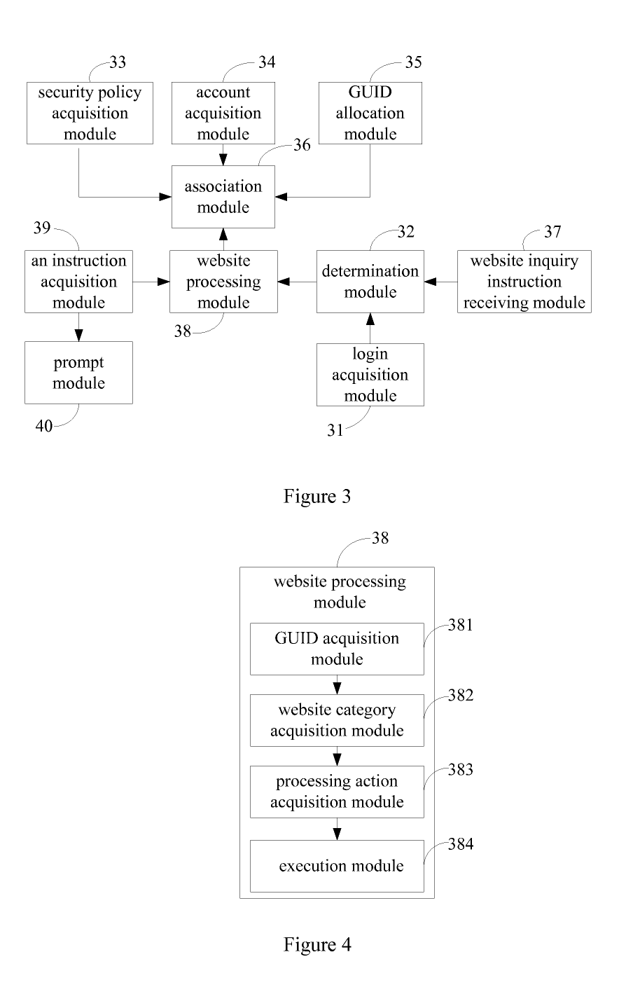

FIG. 3 is an exemplary structural diagram for a cloud based apparatus for monitoring internet usage in accordance with an embodiment of the present invention. As shown in FIG. 3, the apparatus includes a login information acquisition module 31, a determination module 32, a security policy acquisition module 33, an account acquisition module 34, a GUID allocation module 35, an association module 36, a website inquiry instruction receiving module 37, a website processing module 38, an instruction acquisition module 39, and a prompt module 40.

The login information acquisition module 31 is used to receive the login account and password entered by a client. The determination module 32 is used to determine whether the login account and password are consistent with that pre-stored.

If the determination module 32 determines that the login account and password are consistent with that pre-stored, the security policy acquisition module 33 is further used to obtain a security policy set by the client (user), wherein the security policy comprises a plurality of website categories and corresponding processing actions.

The account acquisition module 34 is used to obtains a linked account entered by the client. The GUID allocation module 35 is used to allocate a GUID to the login account corresponding to the client. The association module 36 associates the corresponding login account, GUID, the security policy and the linked account.

During the monitoring of the internet usage by the client, a website inquiry instruction is generated and sent to the cloud. The website inquiry instruction receiving module 37 receives a website inquiry instruction sent by the client, and obtains the website identifier contained in the instruction. The determination module 32 further determines whether the website is a website to be monitored; if so, the website processing module 38 processes the website in accordance with the security policy preset by the client.

FIG. 4 is an exemplary structural diagram for a website processing module 38 in a cloud based apparatus for monitoring internet usage in accordance with an embodiment of the present invention.

As shown in FIG. 4, the website processing module 38 comprises a GUID acquisition module 381, a website category acquisition module 382, a processing action acquisition module 383 and an execution module 384.

The GUID acquisition module 381 is used to obtain the GUID corresponding to the client or the login account; the website category acquisition module 382 is used to obtain the website category of the website identifier; the processing action acquisition module 383 is used to further obtain the corresponding processing action in accordance with the website category obtained by the website category acquisition module 382; and the execution module 384 is used to process the website in accordance with the processing action obtained by the processing action acquisition module 383. The processing action is preferably selected from a group consisting of: denying access to the website, recording accesses to the website in a log, and sending a prompt message to the client.

In FIG. 3, the instruction acquisition module 39 is used to obtain the website inquiry instruction sent by the client, and the determination module 32 is used to determine whether the instruction is consistent with the processing action of the security policy; and if not, the prompt module 40 is used to send a prompt message to the client.

The descriptions of the method embodiments above can be referenced for the operational principle of the apparatus embodiment, which will not be further described here.

In accordance with embodiments the present invention, security policy can be set for websites to be monitored (e.g., pornographic websites) and stored in a server, and enforced by security software on the client through a GUID. When a website inquiry instruction is received from a client, the server determines whether the website is a website to be monitored, and if so, processes the website in accordance with the preset security policy. Since the security policy is stored on a server, it cannot be easily circumvented by the user, and its effectiveness is enhanced.

The various embodiments of the present invention are merely preferred embodiments, and are not intended to limit the scope of the present invention, which includes any modification, equivalent, or improvement that does not depart from the spirit and principles of the present invention, therefore, the scope of the present invention only is defined in accordance with the claims.

1. A cloud based method for monitoring internet usage, comprising:
receiving a website inquiry instruction sent by a client, wherein the instruction comprises a website identifier;
determining whether the website is a website to be monitored; and
if the website is a website to be monitored, processing the website in accordance with a security policy pre-stored in a server.

2. The method of claim 1, further comprising, prior to the step of receiving a website inquiry instruction sent by a client,
obtaining the security policy set by the client, wherein the security policy comprises a plurality of website categories and corresponding processing actions; and
saving the obtained security policy.

3. The method of claim 2, further comprising, prior to step of storing the security policy:
allocating a GUID to the client; and
associating the GUID and the obtained security policy;
wherein processing the website inquiry instruction in accordance with a security policy pre-stored in a server further comprises:
obtaining the GUID allocated to the client;
obtaining a corresponding website category for the website;
obtaining a corresponding processing action for the website category; and
processing the instruction in accordance with the processing action.

4. The method of claim 3, further comprising,
after allocating a GUID to the client:
obtaining a linked account set by the client; and
associating the GUID with the client account;
after processing the website inquiry instruction in accordance with a security policy pre-stored in a server:
obtaining the website inquiry instruction sent by the client;
determining whether the instruction is consistent with the processing action, and if not, sending a prompt message to the client.

5. The method of claim 4, wherein the processing action is selected from a group consisting of: denying access to the website, recording accesses to the website in a log, and sending a prompt message to the client.

6. A cloud based apparatus for monitoring internet usage, comprising:
an instruction receiving module configured to receive a website inquiry instruction sent by a client, wherein the instruction comprises a website identifier;
a determination module configured to determine whether the website is a website to be monitored; and
a website processing module configured to, if the website is a website to be monitored, process the website in accordance with a security policy pre-stored in a server.

7. The apparatus of claim 6, further comprising:
a security policy acquisition module configured to obtain the security policy set by the client, wherein the security policy comprises a plurality of website categories and corresponding processing actions; and
a storage module configured to save the obtained security policy.

8. The apparatus of claim 7, further comprising:
a GUID allocation module configured to allocate a GUID to the client; and
an association module configured to associate the GUID and the obtained security policy;
wherein the website processing module further comprises:
a GUID acquisition module configured to obtain the GUID allocated to the client;
a website category acquisition module configured to obtain a corresponding website category for the website;
a processing action acquisition module configured to obtain a corresponding processing action for the website category; and
an execution module configured to process the website in accordance with the processing action.

9. The apparatus of claim 8, further comprising:
an account acquisition module configured to obtain a linked account set by the client; wherein the association module is further configured for associating the GUID with the client account;
an instruction acquisition module configured to obtain the website inquiry instruction sent by the client; wherein the determination module is further configured for determining whether the instruction is consistent with the processing action; and
a prompt module configured to, if the instruction is not consistent with the processing action, send a prompt message to the client.

10. The apparatus of claim 9, wherein the processing action is selected from a group consisting of: denying access to the website, recording accesses to the website in a log, and sending a prompt message to the client.

11. A cloud based method for monitoring internet usage, comprising:
allocating a GUID to an application on the client;
obtaining a security policy associated with the GUID from a server; and
processing an instruction for accessing a website in accordance with the security policy.

12. The method of claim 11, wherein the application is a security software.

13. The method of claim 11, wherein the application is a plug-in for a browser.

14. The method of claim 11, wherein the GUID is associated with a user account.

15. The method of claim 11, wherein the security policy comprises a plurality of website categories and corresponding processing actions, and the method further comprises:
processing the instruction for access the website in accordance with the processing action corresponding to the website category of the website.

16. An apparatus for monitoring internet usage, comprising:
a storage module configured to store a plurality of security policies;
a GUID allocation module configured to associate a GUID to an application on a client; and
a security policy setting module configured to set a security policy to the application associated with the GUID, where the application associated with the GUID is configured for processing an instruction for accessing a website in accordance with the security policy.

17. The apparatus of claim 16, wherein the application is a security software.

18. The apparatus of claim 16, wherein the application is a plug-in for a browser.

19. The apparatus of claim 16, wherein the GUID is associated with a user account.

20. The apparatus of claim 16, wherein the security policy comprises a plurality of website categories and corresponding processing actions, and the application associated with the GUID is configured to process the instruction for access the website in accordance with the processing action corresponding to the website category of the website.
